(19) United States
(12) Patent Application Publication
(10) Pub. No.: US 2009/0229463 A1
(43) Pub. Date: Sep. 17, 2009

(54) Apparatus and processes for production of coke and activated carbon from coal products

(75) Inventor: Geoffrey R. Wilson, Kittanning, PA (US)

Correspondence Address: RADER FISHMAN & GRAUER PLLC, LION BUILDING, 1233 20TH STREET N.W., SUITE 501, WASHINGTON, DC, 20036, US

(73) Assignee: Coalstar Industries, Inc., Johnstown, PA (US)

(21) Appl. No.: 12/379,139

(22) Filed: Feb. 13, 2009

Related U.S. Application Data
(60) Provisional application No. 61/064,099, filed on Feb. 15, 2008.

(51) Int. Cl. C10G 9/14; B01J 19/00; C01B 31/02; B01D 53/02

(52) U.S. Cl. 95/134; 208/131; 208/95; 422/187; 423/461

(57) ABSTRACT

Production of coke and activated carbon from coal products, including the production of low ash coal and activated carbon products from coal products, and the production of very low ash coke and activated carbon products from coal products.

### CROSS REFERENCE TO RELATED APPLICATIONS

This application claims priority to previously filed U.S. provisional Application Ser. No. 61/064,099, entitled Apparatus and Processes for Production of Coke and Activated Carbon from Coal Products, and filed on Feb. 15, 2008, the entire contents of which are hereby incorporated by reference.

### BACKGROUND OF THE INVENTION

1. Field of the Invention

The inventions herein described relate to the field of fossil fuels and more particularly to fuels derived from coal for production of coke and activated carbon products.

2. Description of the Related Art

The worldwide demand for energy continues to grow annually with an ever increasing need to control the energy generation processes to minimize harmful pollution effects of, for example, discharge into the atmosphere of carbon dioxide, mercury or sulfur by-products. In the United States and other industrial nations, there are expanding government regulations efforts to significantly improve energy generation processes to avoid harmful pollution, e.g., heavy metals such as mercury and sulfur gases from coal-based power electric generating stations.

The United States and other industrial nations are faced with increasing pressure to impose tougher limitations on greenhouse gas emissions which again place substantially higher production costs on companies and increase the difficulty of obtaining governmental permits.

Within the European Union, some of the latest proposals could spark a trade war over global warming issues and similar political issues of regulating emissions. Targeted emissions may include emissions of heavy metals such as mercury, as well as emissions of carbon dioxide and sulfur oxides. These emissions would be a very serious problem for the large number of power plants in the United States in which the steam turbine generators are driven with steam raised by burning coal.

The United States Governments' Clean Air Mercury Rule currently mandates a 70% reduction in mercury emissions from all coal-fired power plants by 2010 and a 90% reduction by 2018. These restrictions will substantially expand the worldwide market for activated carbon production and are estimated in many technical publications to exceed 500 million dollars annually in the US.

United States provisional application Ser. No. 60/907,822, filed by Dr. Harold H. Schobert, entitled “Integrated Process and Apparatus for Carbon Producing Diesel Gasoline and Other Distillate Fuels,” provides further background information to various aspects of these technical arts and developments.

### SUMMARY OF THE INVENTION

As is well known to those skilled in the energy production arts in the United States and many industrial countries, coal for many years has been a readily available source of electric energy. Further, while coal is the one source of energy for which long term supply contracts have been readily available, however as governmental regulations are currently seriously considering much stronger restrictions to impose tougher limitations on greenhouse gas emission and thus likely in the future to impose substantially higher costs on the operation of coal-fired power generating facilities by requiring the installation of additional cleaning equipment on the plant gas emissions.

Many industrial power plants are currently exploring many improvements for coal fired power plants not only to restrict or substantially reduce the emissions of carbon dioxide gases but also to substantially reduce any emissions of undesirable gases such as mercury and oxides of sulfur.

According to one aspect, one or more embodiments of the disclosed inventions improve the operation of coal fired power plants by substantially reducing objectionable emissions including mercury and oxides of carbon and sulfur.

According to another aspect, one or more embodiments of the disclosed inventions substantially improve the economic operation of coal-fired power plants which would occur if the exhaust were to exceed anticipated heightened governmental pollution restrictions.

According to another aspect, one or more embodiments of the disclosed inventions economically improve the operation of coal fired electric power generation plants.

The present invention can be embodied in various forms, including methods, apparatus, systems, manufactures, and the like.

### BRIEF DESCRIPTION OF THE DRAWINGS

These and other more detailed and specific features of the present invention are more fully disclosed in the following specification, reference being had to the accompanying drawings, in which:

FIG. 1A is a schematic flow diagram of apparatus and process for low cost, coal-solvent extraction.

FIG. 1B is a schematic diagram of apparatus and process for low cost, energy efficient coal-solvent extraction.

FIG. 1C is a schematic diagram of apparatus and process for production of activated carbon from coal.

FIG. 1D is a schematic diagram of apparatus and process for production of coal derived oil.

FIGS. 1E-F are block diagrams illustrating integration of activated carbon production with power plant flue gas clean up.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

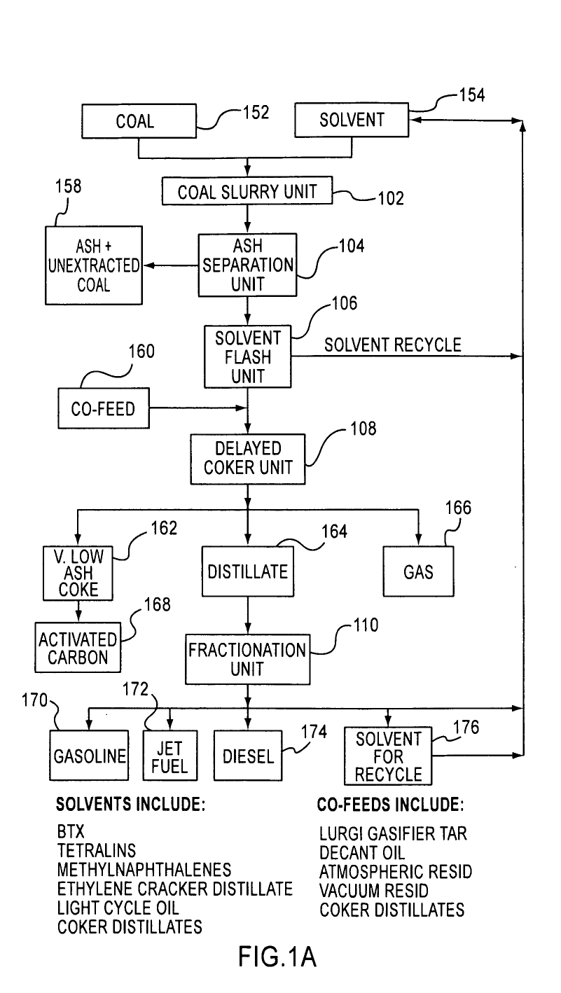

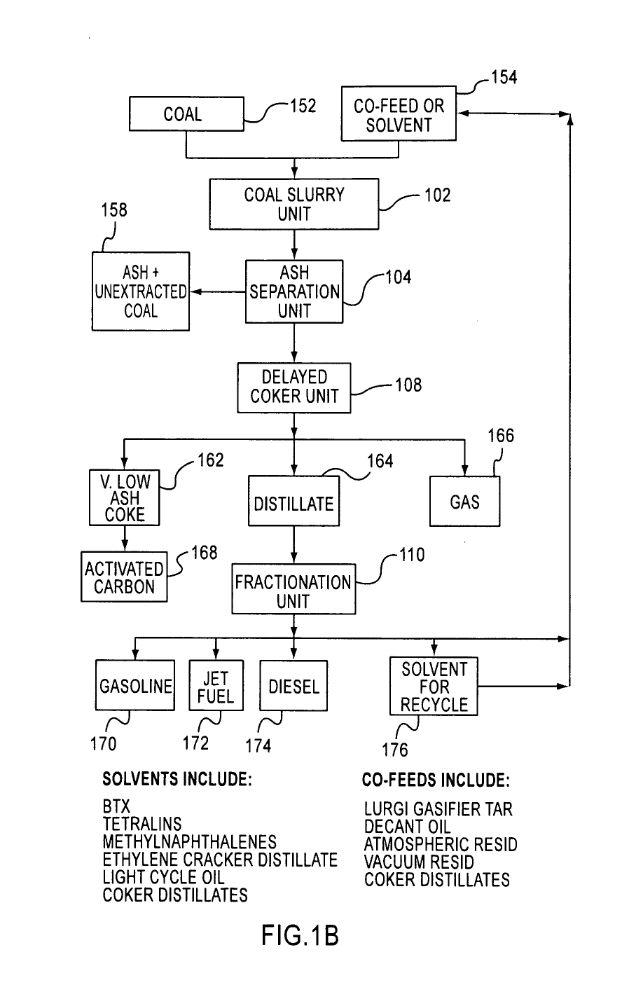

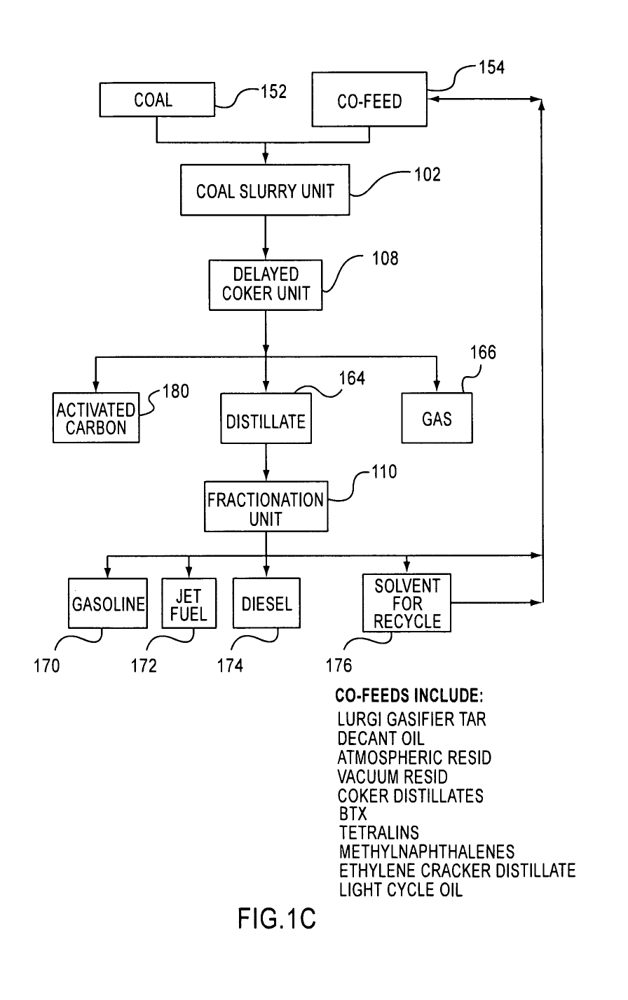

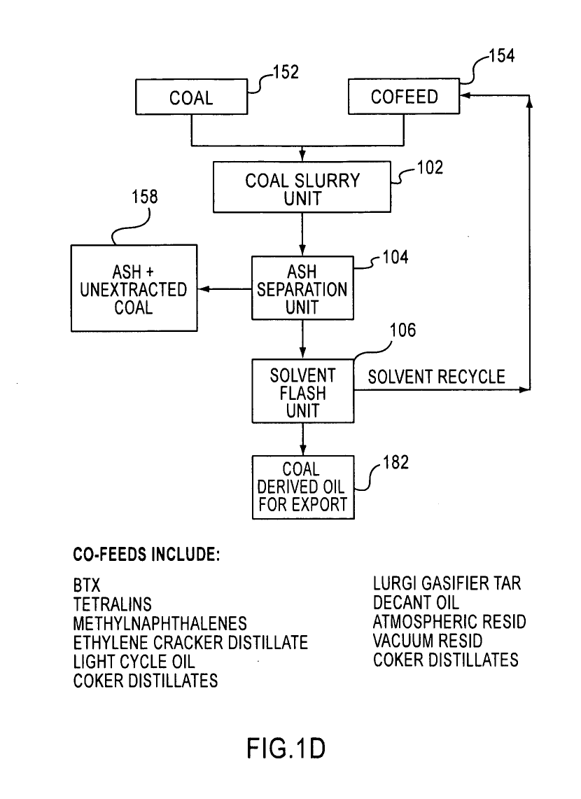

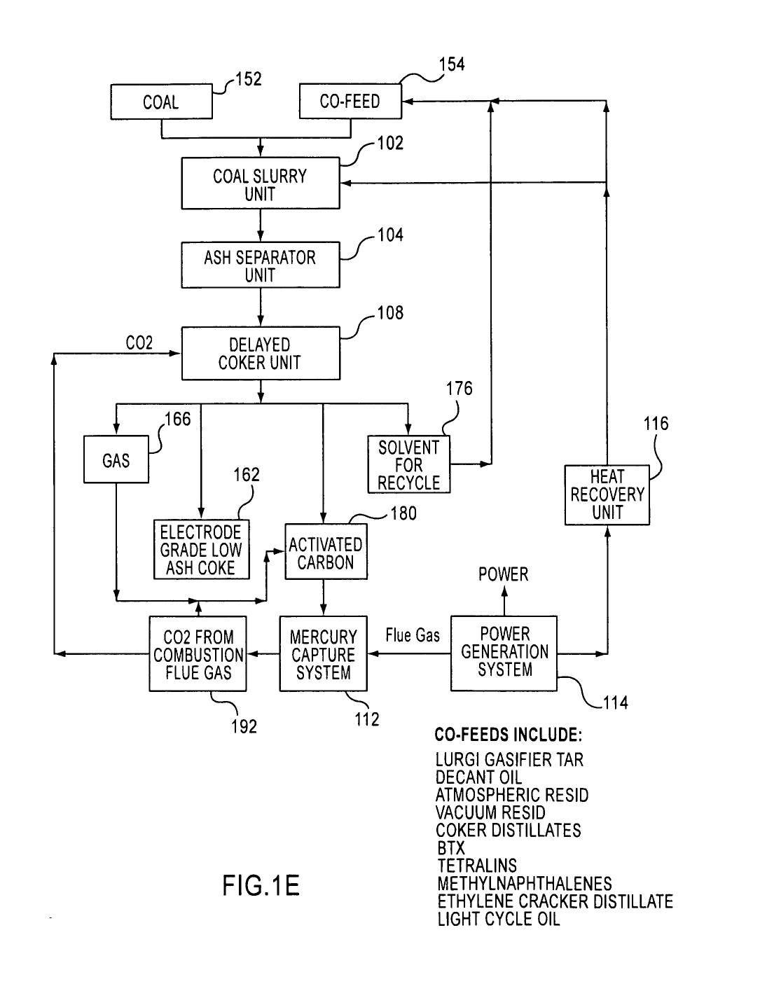

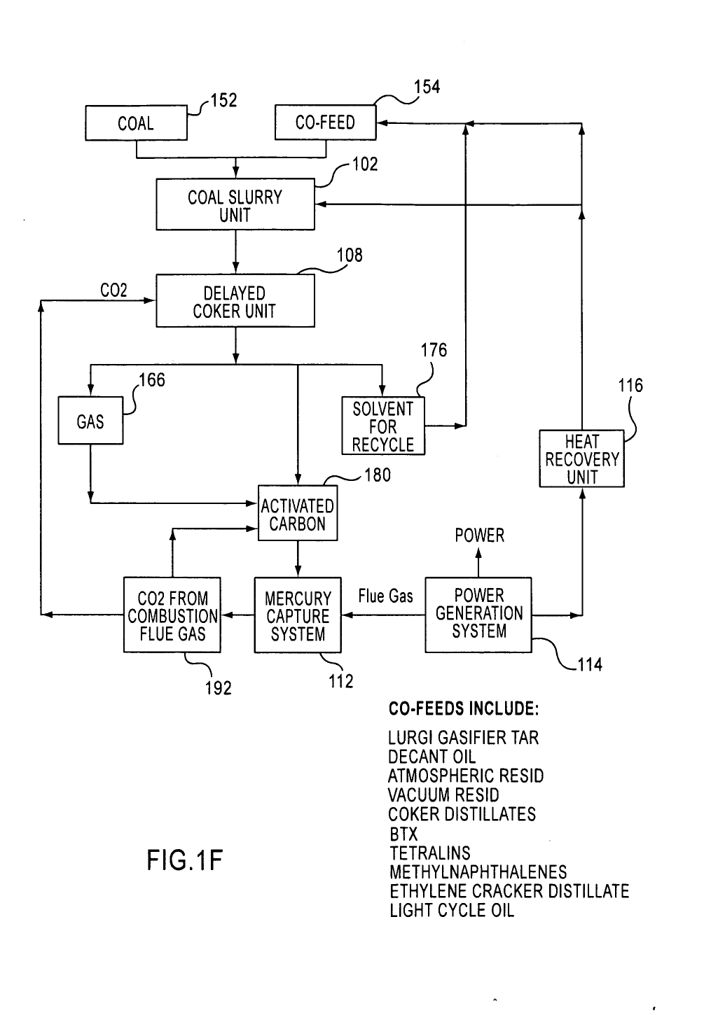

FIGS. 1A and 1B represent processes and corresponding apparatus for production of Low Ash Coke and/or Activated Carbon.

Referring first to FIG. 1A, the apparatus includes a coal slurry mixing unit 102, an ash separation unit 104, a solvent flash unit 106, a delayed coker unit 108, and a fractionation unit 110. Various input and output 152-176 are also illustrated so as to illustrate the operation of the apparatus as well as the corresponding process.

Coal 152 and recycled solvent 154 are input to the coal slurry mixing unit 102. After de-ashing by the ash separation unit 104, which produces ash and un-extracted coal 158, the solvent flash unit 106 performs a flash step to remove oil, suitable for dissolving additional fresh coal, by recycling to the solvent/co-feed input (154). Additional recycle co-feed is produced in the final fractionation step as indicated output from the fractionation unit 110.

One option of the disclosed processes and apparatus offers the production of a substantially ash-free coke, suitable for manufacture of aluminum-smelting anodes. For example, a substantially ash-free coke acceptable as anode coke in the aluminum industry has a maximum of approximately 0.1% ash. With this option, it is useful to input a substantially ash free feed to the delayed coker unit 108.

FIGS. 1A and 1B illustrate processes and apparatus that with appropriate inputs achieve the required substantially ash free coke. Referring first to FIG. 1A, the process entails the following:

(a) Dissolving the coal in a suitable solvent selected from the list illustrated at the bottom of the figure. Namely, in the examples of FIGS. 1A and 1B, exemplary solvents include BTX, tetralins, methylnaphthalenes, ethylene cracker distillate, light cycle oil, and coker distillates. Exemplary co-feeds include but are not limited to Lurgi gasifier tar, decant oil, atmospheric resid, and coker distillates. The solvent(s) and/or co-feed(s) are input (154) to the coal slurry mixing unit 102.

(b) The ash separation unit 104 receives input from the coal slurry mixing unit 102 and separates the solid/liquid slurry downstream of the dissolving performed in the coal slurry mixing unit 102, thereby rejecting almost all the ash and some un-dissolved coal as a solid product.

(c) The solvent flash unit 106 accommodates a flash process that occurs when a liquid stream is transferred into a zone at significantly higher temperature. The liquid stream resulting from the ash separation, which is a solution of coal-derived material in the solvent, is input to the solvent flash unit 106, which substantially removes the solvent from the coal-derived material.

(d) The substantially ash and solvent-free material is output from the solvent flash unit 106 and provided to the delayed coker unit 108, which may also receive co-feed (160). These co-feeds may be variously embodied in the same fashion as the other co-feeds described herein.

(e) Distillate liquid products output from the delayed coker unit 108 are either utilized as a single liquid product (e.g., very low ash coke (162) or gas (166)) or separated into typical refinery fuel fractions for further upgrading, usually by hydro-treating and/or hydrogenation. In the latter case, the intermediate distillate product (164) is input to the fractionation unit 110, with typical gasoline (170), jet fuel (172), diesel (174) outputs, as well as recycled solvent (176) as described.

(f) The solid coke product (162) of delayed coking may then be utilized either as anode grade coke or may be further processed in to activated carbon (168). Activated carbon may be utilized for typical applications such as absorption and purification and may also be used to capture environmentally undesirable heavy metals, such mercury and arsenic, contained in coal or heavy oil burning power plant flue gases produced during the combustion of the fuel. Graphite is also a potential product of this process.

In anode production, the form of carbon itself is significant, with the anisotropic form of carbon being desired. To achieve this decant oil is a desirable petroleum derived stream.

FIG. 1B is identical to FIG. 1A except that the solvent flash unit 106 is eliminated and the co-feed is derived entirely from the final fractionation step. In the variation illustrated in FIG. 1B, the solvent flash is eliminated, resulting in a simplified process and a reduction in equipment, associated capital and a heat consuming step.

FIG. 1C is a schematic diagram of apparatus and process for production of activated carbon (180) from coal. In this apparatus and process, exemplary co-feeds include but are not limited to Lurgi gasifier tar, decant oil, atmospheric resid, vacuum resid, coker distillates, BTX, tetralins, methylnaphthalenes, ethylene cracker distillate, and light cycle oil.

The activated carbon (180) is suitable for reduction of heavy metals, such mercury and arsenic in power plant flue gas. In power plant application integration of the activated carbon production process in to the power plant is desirable. In this application, within reason, the ash content of an activated carbon is not critical, particularly where a low cost product is required. In this application the level of ash rejection upstream of the delayed coker unit 108 is not critical and may be, optionally, eliminated completely. In addition, the basic structure of the carbon itself can be isotropic, which offers more latitude in the nature of the petroleum feed to the coker, which is a possible resid, and not the more expensive decant oil. Therefore, feeds to the delayed coker unit 108 may include coal+resid, a low value refinery product.

FIG. 1D is a schematic diagram of apparatus and process for production of coal derived oil. Particularly, FIG. 1D contemplates production of a coal derived hydrocarbon product (182) suitable for exporting to existing petroleum refineries for upgrading into fuels, thereby supplementing the need for imported crude oil. The apparatus includes the described coal slurry unit 102, ash separation unit 104 and solvent flash unit 106, with solvent recycled to the co-feed/solvent input (154) of the coal slurry unit 102. Exemplary co-feeds include but are not limited to BTX, tetralins, methylnaphthalenes, ethylene cracker distillate, light cycle oil, coker distillates, Lurgi gasifier tar, decant oil, atmospheric resid, vacuum resid, and coker distillates. FIG. 1D differs in two main respects as compared to FIGS. 1A-C. In the example of FIG. 1D, the process and apparatus dissolves coal, separates the ash and un-dissolved coal and produces the coal liquid essentially as a synthetic crude oil. There is no coker and thus no coke or activated carbon, and no fractionation.

FIGS. 1E-F are block diagrams illustrating integration of activated carbon production with power plant flue gas clean up.

The functional components shown in FIGS. 1E-F are similar to the corresponding components or functions of FIGS. 1A-D and need not be redundantly described (including fractionation, not illustrated but present). The illustrated operational components of the coal driven electric power plant generator include a conventional coal based power generation system 114 (with a coal feeder, not shown), as well as a mercury capture system 112. The activated carbon products (180) produced according to the described processes may be input to the mercury capture system 112 in order to further the reduction or elimination of undesirable emissions as described above. As also indicated, the CO2 from the combustion flue gas (192) may be fed back to the process of producing the activated carbon. For improved efficiency in solvent extraction the heat recovery unit 116 of the power generation system is intended to keep the coal slurry operating at a preferred operating temperature in the range of 200-400° Celsius. The input to coal-solvent slurry unit 102 includes the soft coal, preferably crushed or pulverized, and at least one co-feed/solvent. Exemplary co-feeds include but are not limited to Lurgi gasifier tar, decant oil, atmospheric resid, vacuum resid, coker distillates, BTX, tetralins, methylnapthalenes, ethylene cracker distillate, and light cycle oil.

Referring first to FIG. 1E, the coal-solvent slurry is heated to the preferred operational temperature as noted. After the coal-solvent slurry, which is activated by a power agitator (not shown), reaches the desired coal dissolved range of sixty to seventy percent of the coal charge, the ash separation unit 104 removes ash and un-extracted coal. After this removal by the ash separator the mixture of un-dissolved coal and dissolved coal-solvent liquid is input to the delayed coker unit 108. The CO₂ from combustion flue gas (192) can be fed to the delayed coker, or, alternatively, directly to the activated carbon unit that produces the activated carbon (180). Where the flue gas is fed to the delayed coker, it may react therein as described, but even if the temperature is not sufficient to consume the CO₂, the gas will pass to the activated carbon unit where the operating temperature is higher, to ensure a reaction that will consume the CO₂. Output from the activated carbon unit is transferred to the mercury capture system 112 and the exhaust flue control solution to avoid exhaust of mercury from the exhaust flue of the electric power plant. Output from the delayed coker unit 108 also results in electrode grade low ash coke (162), which, for example, produces coke products for the manufacture of aluminum-smelting anodes for sale to the electric industry.

Mixing coal with a very heavy solvent, such as vacuum resid, coal tar pitch, or petroleum pitch, and then feeding this mixture into a coker/activation furnace with CO2 and/or steam could be a direct route to an activated carbon product with a reduced number of processing steps.

FIG. 1F illustrates the processes wherein the ash separation unit is omitted. This results in the process that does not generally result in sufficient yield of electrode grade low ash coke, but does provide a more economical production of activated carbon usable for undesirable emissions reduction.

For a more complete understanding of the structure and operation of the solvent extraction units illustrated in FIGS. 1A-F, it may be helpful to have reference to the example of a process as set forth below:

Step 1—Fill the coal-solvent slurry mixing unit 102 at a preferred ratio of 10:1 by weight of soft coal to a light cycle oil or alternate solvents described previously.

Step 2—Agitate the soft coal-solvent slurry in the mixing unit 102 until on the order of 60 to 70% of the added coal has been dissolved at the preferred operating temperature range of 200-400 degrees C.

Step 3—Where required (e.g., not in FIG. 1C or 1F), separate any coal ash and un-dissolved coal from the dissolved coal-solvent liquid in an ash separator unit 104.

Step 4—Feed the output of the ash separator unit 104, which comprises approximately 30% un-dissolved coal and 70% dissolved coal and solvent liquid into a delayed coker unit 108.

Step 5—Feed the output of the delayed coker unit 108 to three separate processing units in predetermined portions: a very low coker to produce very low ash coke for manufacturing aluminum-smelting anodes, an activated carbon production unit which in addition to being fed with coke from the delayed coker unit 108 may optionally be fed with carbon dioxide and gases produced in the coker and distillation train for processing the coker liquid products known as coker distillates, a portion of which may be recycled to the coal slurry unit 102 while the balance is sent to additional refinery processing for upgrading to fuels such as gasoline, jet and diesel.

Finally, it is noted that with any or all of the described processes, various coal cleaning may be implemented prior to introduction into the processes. Whether and to what degree such is undertaken is a function of the desired grade and type of product(s) that are intended as a result of the processes, as well as other considerations such as the cost of such cleaning.

Thus embodiments of the present invention produce and provide Apparatus and Processes for Production of Coke and Activated Carbon from Coal Products. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A process for producing low ash coke products from coal products, the process comprising:
producing a coal slurry liquid by mixing pulverized coal and a coal solvent in predetermined proportions in an agitated container unit; and
applying ash separation to the coal slurry liquid to remove ash and un-extracted coal to produce a substantially ash-free coal slurry liquid;
feeding the substantially ash-free coal slurry liquid into a delayed coker unit to produce low ash coke.

2. The process of claim 1, wherein the low ash coke is of a grade suitable for producing quality electric anode material.

3. The process of claim 1, further comprising:
performing a solvent flash process to the substantially ash-free coal slurry liquid to substantially remove the coal solvent prior to feeding the substantially ash-free coal slurry liquid to into the delayed coker unit.

4. The process of claim 1, wherein producing the coal slurry liquid is performed in the agitated container unit at a temperature in the range of 200-400 degrees C.

5. The process of claim 4, wherein producing the coal slurry liquid is performed in the agitated container unit until approximately 70% by weight of the pulverized coal is dissolved.

6. The process of claim 1, further comprising: separating the coker distillate by fractionation to produce gasoline jet and/or diesel fuel.

7. The process of claim 1, wherein the predetermined approximate proportions of pulverized coal and the coal solvent are initially in a ratio of 1:5 by weight until approximately 70% of the coal is dissolved by the solvent.

8. The process of claim 3, wherein after the specified mixing, the contents of the mixing unit comprises ash, undissolved coal in the amount of approximately 30% of the coal charge and coal dissolved in the solvent largely derived from the recycle process.

9. An apparatus for producing low ash coke products from coal products, the apparatus comprising:
means for producing a coal slurry liquid by mixing pulverized coal and a coal solvent in predetermined proportions in an agitated container unit;
means for applying ash separation to the coal slurry liquid to remove ash and un-extracted coal to produce a substantially ash-free coal slurry liquid; and
means for feeding the substantially ash-free coal slurry liquid into a delayed coker unit to produce low ash coke.

10. The apparatus of claim 9, wherein the low ash coke is of a grade suitable for producing quality electric anode material.

11. The apparatus of claim 9, further comprising:
means for performing a solvent flash process to the substantially ash-free coal slurry liquid to substantially remove the coal solvent prior to feeding the substantially ash-free coal slurry liquid to into the delayed coker unit.

12. A process for producing activated carbon products from coal products, the process comprising:
producing a coal slurry liquid by mixing pulverized coal and a coal solvent in predetermined proportions in an agitated container unit;
introducing the coal slurry liquid into a delayed coker unit to produce a solid coke product; and
feeding carbon dioxide to the delayed coker unit and/or the activated carbon unit to produce activated carbon.

13. The process of claim 12, further comprising:
using the activated carbon in a mercury capture system to accommodate reduction of undesirable emissions from flue gas of a power generation system in which the process is carried out.

14. An integrated solvent extraction process combined with an operable coal driven electric generation power plant for producing coke and activated carbon products, the process comprising:
mixing pulverized soft coal and a solvent selected from a group consisting of atmospheric resid, vacuum resid, BTX, decant oil, light cycle oil, Lurgi gasifier tar, methylnapthalenes, coker distillates, ethylene cracker distillate or tetralins;
heating the soft coal solvent slurry to a temperature in the range of 200-400 degrees Celsius; separating the coal ash from the dissolved coal-solvent mixture, introducing the un-dissolved coal and solvent liquid into a delayed coker unit to develop very low ash coke; and
combining carbon dioxide with a portion of the un-dissolved coal to form activated carbon products.

15. The process of claim 14, wherein power plant exhaust is utilized to heat the soft coal-solvent slurry to an operating temperature in the range of 200-400 degrees C.

16. The process of claim 14, wherein the carbon dioxide gas introduced with the combining step of claim 5 is collected as a by-product from the normal operation of the electric generation plant.

17. Apparatus for producing very low ash coke and activated carbon products from coal products, the apparatus comprising:
means for mixing a pulverized soft coal-solvent solution until approximately 70% of the pulverized coal is dissolved;
means for separating the un-dissolved coal and coal ash from the dissolved coal-solvent liquid; and
a delayed coker unit for treating the un-dissolved coal and the dissolved coal-solvent liquid to generate a very low ash coke suitable for manufacturing high quality electric anode materials, and means for combining a portion of the un-dissolved coal with carbon dioxide to produce activated carbon products.

18. The apparatus of claim 17, further comprising:
means to recycle up to 90% of the dissolved coal-solvent liquid for utilization in a subsequent solvent extraction process.

19. The apparatus of claim 17, further comprising:
means for utilizing carbon dioxide gas from the associated power plant to produce the activated carbon products.
